(19) United States
(12) Patent Application Publication
(10) Pub. No.: US 2007/0073504 A1
(43) Pub. Date: Mar. 29, 2007

(54) Configurable component handling device

(75) Inventors: Feng Xu, Cheshire, CT (US); Anthony J. Alexander, Cheshire, CT (US); Christopher J. Bernard, Cheshire, CT (US)

Correspondence Address: LOUIS J. WILLE;BRISTOL-MYERS SQUIBB COMPANY, PATENT DEPARTMENT, P O BOX 4000, PRINCETON, NJ, 08543-4000, US

(73) Assignee: Bristol-Myers Squibb Company

(21) Appl. No.: 11/526,474

(22) Filed: Sep. 25, 2006

Related U.S. Application Data
(60) Provisional application No. 60/720,992, filed on Sep. 27, 2005.
(60) Provisional application No. 60/720,556, filed on Sep. 26, 2005.

(51) Int. Cl. G01F 25/00

(52) U.S. Cl. 702/100

(57) ABSTRACT

A configurable component handling device and a method for implementing the configurable component handling device is provided, wherein the configurable component handling device includes a chromatograph and a plurality of processing modules, wherein the chromatograph and each of the plurality of processing modules are communicated with each via at least one configurable flow actuation device to allow for directional flow control of a sample solution between the plurality of processing modules, the method includes introducing a sample solution into the configurable component handling device and processing the sample solution via the configurable component handling device to isolate a desired component.

### CROSS-REFERENCE TO RELATED APPLICATIONS

This application claims the benefit of U.S. Provisional Application Ser. Nos. 60/720,992 filed Sep. 27, 2005 and 60/720,556 filed Sep. 26, 2005.

### FIELD OF THE INVENTION

This disclosure relates generally to the handling of a fluid and more particularly to the preparation of a component in a fluid for analysis.

### BACKGROUND OF THE INVENTION

The use of liquid chromatography (LC) coupled with solid-phase extraction (SPE) and nuclear magnetic resonance (NMR) for analyzing mixtures originating from natural product extracts, drug metabolites and pharmaceutical impurities is known in the art and has resulted largely from the capability of LC-SPE to isolate, enrich and allow NMR analysis of an individual analyte that may be present in a complex mixture. This is because LC-SPE-NMR, which is essentially limited to analytical-scale liquid chromatography (αLC), provides sensitivity enhancements over conventional LC-NMR analysis of a mixture where the components are diluted onto the LC column. Moreover, αLC-SPE has also been used in conjunction with an NMR cryogenic probe to increase the detection sensitivity of αLC-SPE-NMR.

However, NMR trace analysis of low-level, low-concentration components in a complex mixture is one of the most difficult analytical tasks undertaken in the pharmaceutical industry and is frequently required in support of metabolite analysis, drug synthesis scale-up or route optimization, drug stability studies, and the characterization of impurities exceeding regulatory limits, wherein the NMR trace analysis includes a limiting characteristic which almost invariably involves the preparation of the sample (i.e. analyte isolation and enrichment). One traditional off-line method used to address this limitation involves using a preparative, often multi-step, high pressure liquid chromatography (HPLC) approach which, despite advances in on-line NMR technology, is necessitated by the fact that the on-line system is still largely confined to the use of analytical scale chromatography typically unsuitable for effectively processing very low-level mixture components.

Despite advances in αLC -SPE-NMR the routine acquisition of two-dimensional ¹H—¹³C data is mostly limited to the study of relatively concentrated components, wherein the study of components having lower concentrations typically requires repeated LC runs and multiple trappings to obtain a sufficient NMR sensitivity level for study, with or without a cryogenic probe. This limitation tends to lead to extended experimentation times which, in some circumstances, may compromise the analytical efficiency of αLC -SPE-NMR. One reason for this is that the LC dimension is typically optimized for analytical-scale HPLC and is subject to the inherent limitations of the HPLC and although large scale preparative, or semi-preparative, LC has been used in an off-line capacity to isolate effectively low-level analytes for NMR analysis, this approach is typically time consuming and lacks the efficiency of the integrated on-line approach.

It has recently been shown that the use of semi-preparative chromatography coupled to NMR (through SPE) for low-level component analysis is possible in the right situation. For example, heteronuclear ¹H—¹³C data was obtained from a low-level component and two-dimensional ¹H—¹H data was obtained from a trace level analyte, both of which were acquired using a room-temperature flow probe. Unfortunately however, in an HPLC method scale-up, the resolution achieved on the larger column may be compromised by inherently greater peak tailing and/or peak fronting. For example, in trace analysis “sample displacement” and “tag-along” effects due to mass overload from the major component can easily distort the peak shape of the minor components and is particularly true in the case of drug impurity analysis, where the active pharmaceutical ingredient (API), is normally present in vast excess. Moreover, other factors, such as the need to use larger than scale injection volumes to counteract low solubility of the API may also adversely affect peak width due to volume overload. Clearly, both of these outcomes are undesirable.

### SUMMARY OF THE INVENTION

A component handling device is provided, wherein the component handling device includes a chromatograph and a plurality of processing modules, wherein the chromatograph and each of the plurality of processing modules are communicated with each via at least one configurable flow actuation device, wherein the flow actuation device allows for directional flow control of a solution between the plurality of processing modules.

A method for implementing a configurable component handling device is provided, wherein the configurable component handling device includes a chromatograph and a plurality of processing modules, wherein the chromatograph and each of the plurality of processing modules are communicated with each via at least one configurable flow actuation device to allow for directional flow control of a sample solution between the plurality of processing modules, the method includes introducing a sample solution into the configurable component handling device and processing the sample solution via the configurable component handling device to isolate a desired component.

### BRIEF DESCRIPTION OF THE DRAWINGS

The foregoing and other features and advantages of the present invention will be more fully understood from the following detailed description of illustrative embodiments, taken in conjunction with the accompanying drawings in which like elements are numbered alike:

FIG. 1 is an overall schematic block diagram of a Configurable Component Handling Device, in accordance with the present invention;

FIG. 2 is a schematic block diagram of a plurality of function module for the Configurable Component Handling Device of FIG. 1, in accordance with the present invention;

FIG. 3 is a schematic flow diagram showing one embodiment of an operational flow for the Configurable Component Handling Device of FIG. 1, in accordance with the present invention;

FIG. 4 is a block diagram illustrating a method for implementing the Configurable Component Handling Device of FIG. 1, in accordance with the present invention;

FIG. 5 is a graph showing a semi-preparative isocratic separation of a sample component disposed in a fluid using the Configurable Component Handling Device of FIG. 1, in accordance with the present invention;

FIG. 6 is a graph showing the analytical gradient separation of the final peak isolation of the sample component disposed in the fluid of FIG. 5; and

FIG. 7 is a graph showing the 2D ¹H—¹H long range correlation experiments of the final isolated analyte of interest (Propranolol).

### DETAILED DESCRIPTION

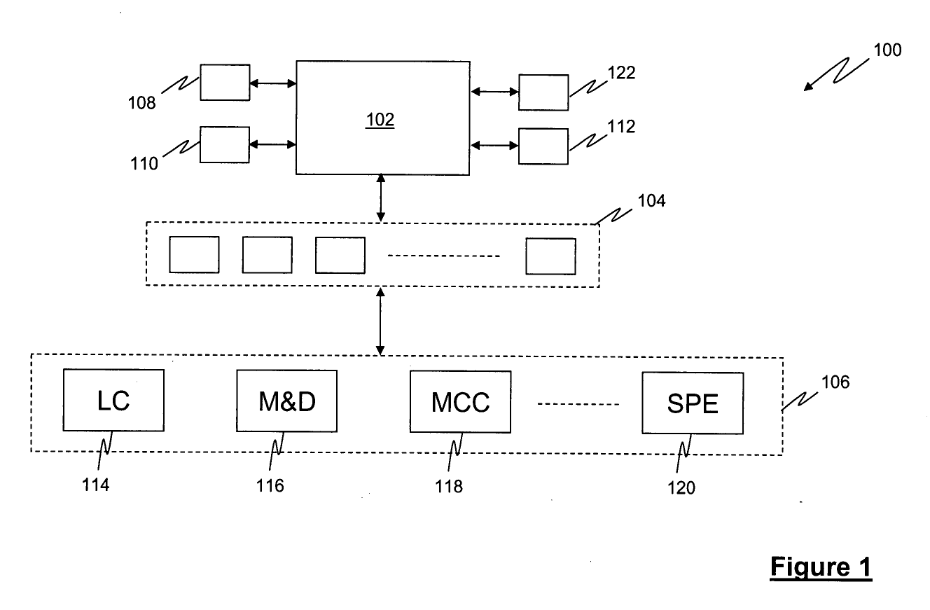

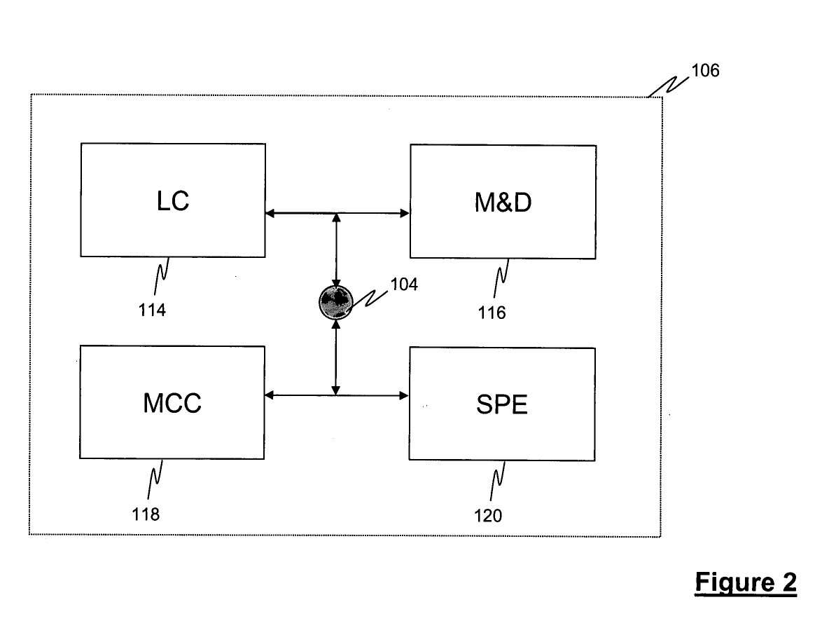

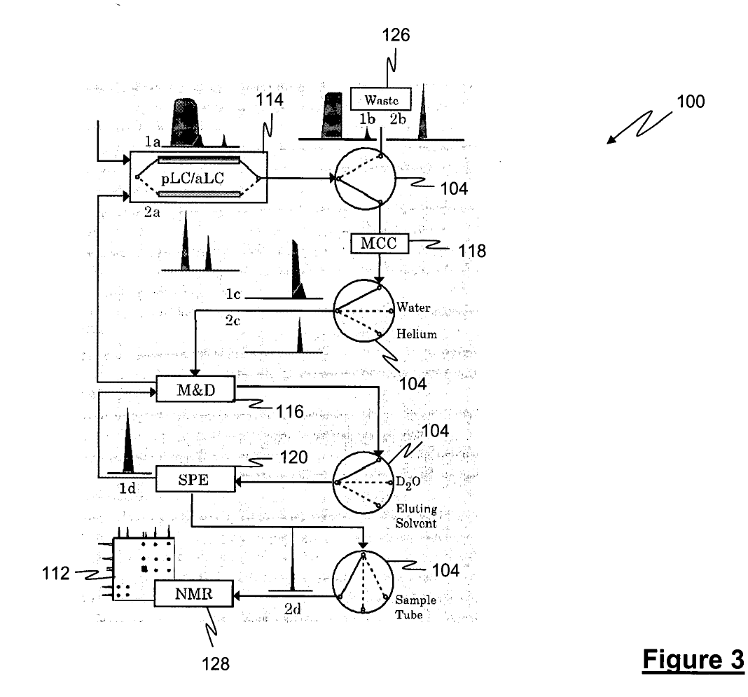

Referring to FIG. 1, FIG. 2 and FIG. 3, a block diagram of a configurable fluidic handling device (CFHD) 100 in accordance with an exemplary embodiment is illustrated and includes a chromatograph 102, a plurality of programmable multi-positional switching devices 104 and a plurality of main function modules 106. The chromatograph 102 includes a pump 108, a processing device 110 and at least one UV-Vis detector 112 and the plurality of main function modules 106 includes a liquid chromatography (LC) module 114, a multiple component collector (MCC) module 116, a mixing & dilution (M&D) module 118 and a solid phase extraction (SPE) module 120. The LC module 114 may be configurable to operate with various column sizes from a narrow bore column size to a preparative column size and the MCC module 116 may include at least one sample injection loop having a predetermined and/or configurable volume. The M&D module 118 may include a plurality of dilution systems each of which may include an on-line liquid storage and mixing device, such as a High Capacity Rotating & Mixing Tube (HiCRAM), which is movably associated with the M&D module 118 to be configurable between a first configuration and a second configuration and having predetermined and/or configurable volumes.

The at least one secondary mixing device 118 may be configurable to have a variable volume (which may be based off of syringe technology) and the SPE module 120 may be comprised of a plurality of SPE cartridges disposed in a parallel fashion with each other to create a parallel flow path. It should be appreciated that each of the LC module 114, MCC module 116, M&D module 118 and SPE module 120 may be separately and controllably configurable to allow each of the LC module 114, MCC module 116, M&D module 118 and SPE module 120 to interact with any and/or all of the LC module 114, MCC module 116, M&D module 118 and SPE module 120, either individually or as a group. It should be further appreciated that each of the switching devices and the modules may be operably associated with the processing device 110 via any communications method and/or device suitable to the desired end purpose, such as an RS-232 connection and a wireless connection. A data acquisition device 122 is also included and may be controllably communicated with the processing device 110 to allow for data acquisition and processing. Moreover, the CFHD 100 may be controllable via software utilizing a Graphical User Interface (GUI), wherein the software GUI may comprise a series of menus to allow the user to interact with the hardware components individually or in a group and wherein a run-table engine may be used to programmatically develop and employ automatic execution of valve positions in a random and/or scheduled manner.

It should be appreciated that the CFHD 100 allows for the controllable operation of some and/or all operations (sample injection, peak cutting, analyte mixing/dilution, trapping, elution, re-injection, etc), wherein liquid flows were monitored by a plurality of detectors which may include dual and/or single wavelength detectors. The detector output may then be acquired by the data acquisition device 122 and stored via any storage method and/or device suitable to the desired end purpose, such as magnetic media and/or optical media. It should be appreciated that although the CFHD 100 includes four main modules: an LC module 114, a multiple component collector (MCC) module 116, a mixing and dilution (M&D) module 118 and an SPE module 120, other processing modules may be included. Moreover, each module may directionally interact with at least one other module to allow for a directionally configurable sample transfer. For example, using the CFHD 100, components isolated via the SPE module 120 from the primary column may be controllably transferred between modules (such as from the dilution module 118 to the LC module 114 for injection onto the secondary column). This configuration allows an injection solvent for the second dimension to be tailored (in terms of organic content, pH, etc) for effective sample focusing on the secondary column. In addition, this flow directional capability offers considerable flexibility in the use of similar or complementary columns, in the secondary dimension and for the design of optimum isolation protocols.

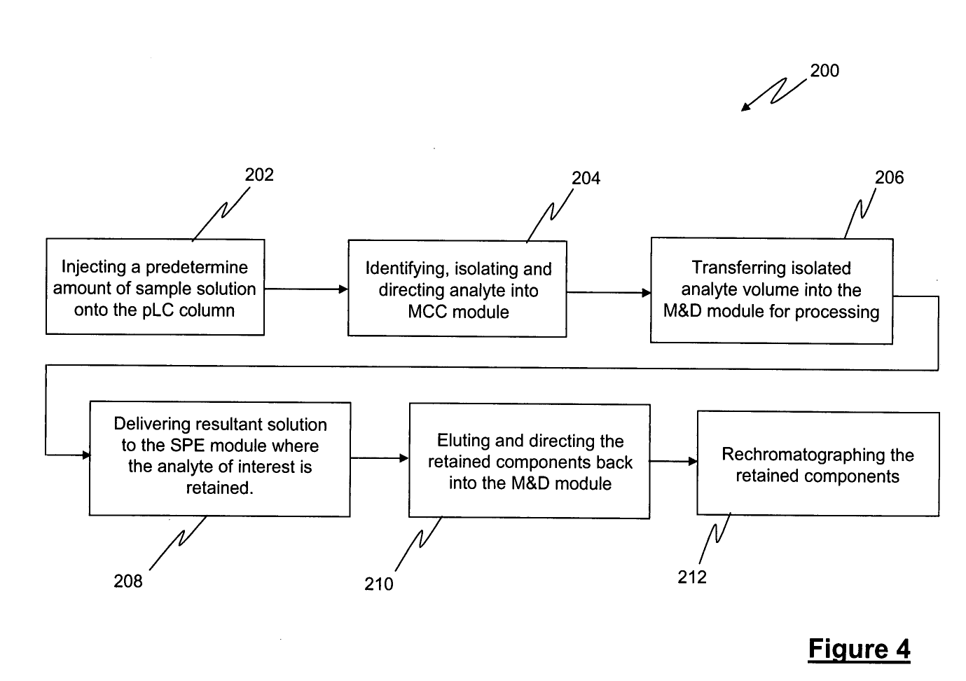

Referring to FIG. 1, FIG. 2, FIG. 3 and FIG. 4, a block diagram illustrating one embodiment of a method 200 for implementing the CFHD 100 is shown and includes initiating an experimental run by injecting a predetermined amount of sample solution onto the pLC column 124, as shown in operational block 202. An analyte peak of interest is identified, isolated and directed into the MCC module 116, as shown in operational block 204 and the remaining components may be directed to a waste container 126. The isolated analyte volume may then be transferred into the M&D module 118 for processing, as shown in operational block 206, where the organic content of the mobile phase may be reduced as desired. The resulting solution may then be delivered to the SPE module 120, as shown in operational block 208, where the analyte of interest, plus any other co-eluting components are retained (trapped). It should be appreciated that the components and/or fluids may be transferred throughout the CFHD 100 via any device and/or method suitable to the desired end purpose, such as via compressed gas.

The retained (trapped) component(s) may then be eluted, for example with acetonitrile, and directed back into the M&D module 118 (which may be reconfigured for re-processing), as shown in operational block 210, where the sample output of the M&D module 118 may then be loaded into an injection loop. It should be appreciated that this sample output may not be a non-optimum sample volume for an analytical scale column. If not, the sample may then be re-chromatographed, as shown in operational block 212, in the αLC dimension to give an optimal separation of all components. As the analyte of interest is now well resolved, the above automated isolation procedure may easily be repeated to isolate the desired analyte and direct the isolated analyte into an NMR probe 128. It should be appreciated that the advantages of using a smaller diameter column in the second dimension results directly from the concomitant reduction in peak volume with column diameter. This results in less water being required for dilution prior to trapping by the SPE module 120, which translates directly into shorter SPE loading times and less “chemical noise” arising from the concentration of non-sample related trace level materials.

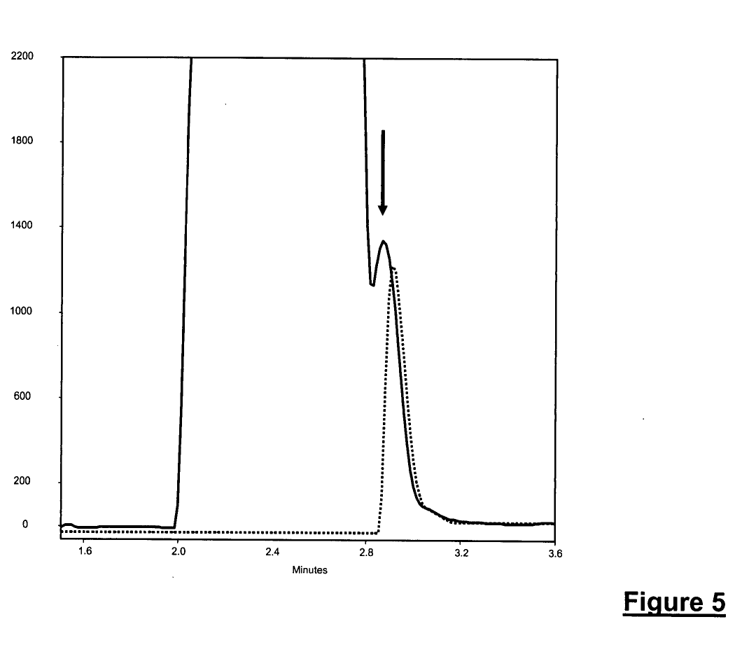

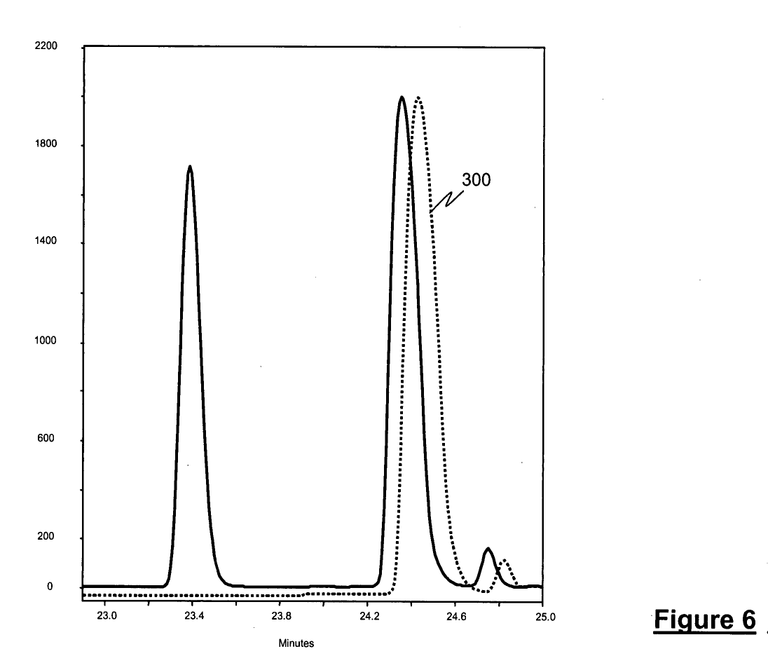

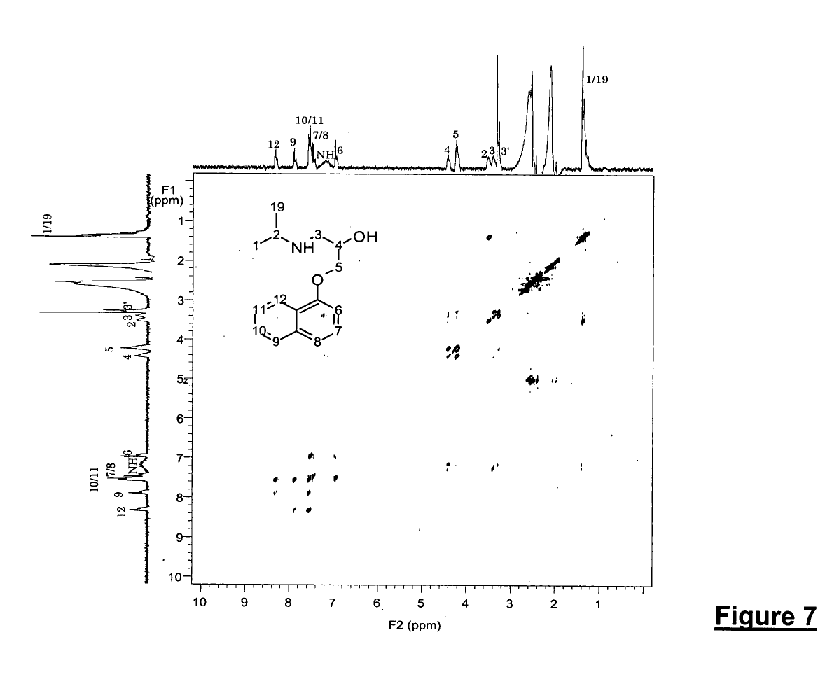

As an example, referring to FIG. 5 and FIG. 6, the results of the implementation of the CFHD 100 (LC²-SPE-NMR) are shown for the processing of a two component mixture of Buspirone and Propanolol, which was used to simulate an API containing a minor component at the 0.1% level (10 μg ml⁻¹), respectively. The pLC separation was carried out under typical conditions used to maximize the column loading and minimize the run time that is a 1 ml injection of a 10 mg ml −1 sample in water followed by a rapid isocratic elution. Under these conditions the resolution on the semi-preparative column may be less than optimal for the analyte of interest (Propanolol). However, implementation of the CFHD 100 results in the analyte of interest (Propanolol) being well separated from Buspirone in the second dimension. In this example, the composite peak from 2.8 to 3.1 minutes, as shown in FIG. 5 (peak volume 1.5mls) was processed using the CFHD 100 via the method 200 of FIG. 4. Referring to FIG. 6, the resulting analytical LC separation of the peak cut from 2.8-3.1 min is shown, wherein the dotted trace 300 shows the fully isolated Propanolol after being further processed using the CFHD 100 via the method of FIG. 4. As shown in FIG. 7, the resulting 2D ¹H—¹H spectrum of Propanolol, obtained from approximately 10 mg of analyte, is of sufficient quality for use in structural analysis.

In accordance with an exemplary embodiment, processing of the method 200 in FIG. 4, in whole or in part, and may be implemented through a processing device operating in response to a computer program which may have a Graphical User Interface for user controlled operation or which may be automatic. In order to perform the prescribed functions and desired processing, as well as the computations therefore (e.g., the execution of fourier analysis algorithm(s), the control processes prescribed herein, and the like), the controller may include, but not be limited to, a processor(s), computer(s), memory, storage, register(s), timing, interrupt(s), communication interfaces, and input/output signal interfaces, as well as combinations comprising at least one of the foregoing. For example, the controller may include signal input signal filtering to enable accurate sampling and conversion or acquisitions of such signals from communications interfaces. It is also considered within the scope of the invention that the processing of the method 200 of FIG. 4, in whole or in part, and may be implemented by a controller located remotely from the processing device.

Moreover, in accordance with an exemplary embodiment, the above embodiment(s) can be embodied in the form of computer-implemented processes and apparatuses for practicing those processes. The above can also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. Existing systems having reprogrammable storage (e.g., flash memory) can be updated to implement the invention. The above can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to an exemplary embodiment, it should be understood by those skilled in the art that various changes may be made and equivalents may be substituted for elements thereof without departing from the scope of the invention. In addition, many modifications may be made to adapt a particular situation or material to the teachings of the invention without departing from the scope thereof. Therefore, it is intended that the invention not be limited to the particular embodiment disclosed as the best mode contemplated for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

We claim:

1. A component handling device comprising:
a chromatography and
a plurality of processing modules, wherein said chromatograph and each of said plurality of processing modules are communicated with each via at least one configurable flow actuation device, wherein said flow actuation device allows for directional flow control of a solution between said plurality of processing modules.

2. The component handling device of claim 1, wherein said plurality of processing modules includes at least one of a liquid chromatography module, a multiple component collector module, a mixing and dilution module and a solid phase extraction module.

3. The component handling device of claim 1, wherein said plurality of processing modules includes a liquid chromatography (LC) module, wherein said LC module is configurable for operation with various sizes of liquid chromatography columns.

4. The component handling device of claim 1, wherein said plurality of processing modules includes a multiple component collector (MCC) module, wherein said MCC module includes at least one injection loop having a configurable loop volume.

5. The component handling device of claim 1, wherein said plurality of processing modules includes a mixing and dilution (M&D) module, wherein said M&D module includes at least one dilution system having at least one of a liquid storage device and a mixing device.

6. The component handling device of claim 5, wherein said M&D module is a high capacity rotating and mixing tube (HiCRAM) having a configurable volume, wherein said HiCRAM is configurable between a first configuration and a second configuration.

7. The component handling device of claim 1, wherein said plurality of processing modules includes a solid phase extraction (SPE) module, wherein said SPE module includes a plurality of SPE cartridges disposed in a parallel fashion relative to each other to create a parallel flow path.

8. The component handling device of claim 1, wherein each of said plurality of processing modules is independently controllable and configurable from the other of said plurality of processing modules.

9. The component handling device of claim 1, wherein said at least one configurable flow actuation device includes a plurality of configurable flow actuation devices, wherein each of said plurality of configurable flow actuation devices is controllable and configurable independently of the others of said plurality of configurable flow actuation devices.

10. The component handling device of claim 1, further comprising a Nuclear Magnetic Resonance (NMR) probe communicated with at least one of said plurality of processing modules via said at least one configurable flow actuation device.

11. A method for implementing a configurable component handling device, wherein the configurable component handling device includes a chromatograph and a plurality of processing modules, wherein the chromatograph and each of the plurality of processing modules are communicated with each via at least one configurable flow actuation device to allow for directional flow control of a sample solution between the plurality of processing modules, the method comprising:
introducing a sample solution into the configurable component handling device; and
processing said sample solution via the configurable component handling device to isolate a desired component.

12. The method of claim 11, wherein said introducing includes introducing a predetermined amount of the sample solution into the configurable component handling device via the chromatograph.

13. The method of claim 11, wherein said processing includes, isolating at least a portion of said sample solution via the LC module; and analyzing said at least a portion of said sample solution via an Nuclear Magnetic Resonance probe to identify a predetermined analyte.

14. The method of claim 11, wherein said processing further includes, isolating at least a portion of said sample solution via the LC module, wherein said at least a portion of said sample solution includes a waste component and a analyte component;
identify said analyte component; and
introducing said at least a portion of sample solution to a multiple component collector (MCC) module to separate said waste component and said analyte component from said at least a portion of said sample solution, wherein said MCC module includes at least one injection loop having a configurable loop volume.

15. The method of claim 14, wherein said processing further includes, introducing said analyte component into a mixing and dilution (M&D) module for further processing, wherein said M&D module generates resultant solution by reducing an organic portion of said analyte component.

16. The method of claim 15, wherein said processing further includes retaining said analyte component within a solid phase extraction (SPE) module.

17. The method of claim 16, wherein said processing further includes eluting said analyte component and re-introducing said analyte component back into said M&D module.

18. The method of claim 17, wherein said processing further includes introducing said analyte component into the chromatograph for further chromatographing.

19. The method of claim 17, wherein said processing further includes analyzing said analyte component via a Nuclear Magnetic Resonance probe.
